(19) United States
(12) Patent Application Publication
(10) Pub. No.: US 2025/0017191 A1
(43) Pub. Date: Jan. 16, 2025

(54) THERMAL FOGGER METHOD AND SYSTEM FOR CREATING STABLE AEROSOLS

(71) Applicant: 1,4Group, Inc., Meridian, ID (US)

(72) Inventors: Eric Nygard, Boise, ID (US); Jason Phillips, Boise, ID (US); Bryan Carson, Eagle, ID (US)

(21) Appl. No.: 18/769,387

(22) Filed: Jul. 11, 2024

Related U.S. Application Data
(60) Provisional application No. 63/526,433, filed on Jul. 12, 2023.
(60) Provisional application No. 63/625,630, filed on Jan. 26, 2024.

(51) Int. Cl. A01M 1/20; A01M 7/00; A01N 25/06

(52) U.S. Cl. CPC A01M 1/2072; A01M 7/0089; A01N 25/06

(57) ABSTRACT

An improved process for applying herbicides, insecticides and the like, as an aerosol or vapor using a thermal fogging apparatus. Particular methods can be performed through use of a programmable logic controller (PLC) that receives data and controls the main components of a thermal fogger system.

### CROSS-REFERENCE TO RELATED APPLICATION

This application claims the benefit of U.S. Provisional Patent Application No. 63/526,433 filed Jul. 12, 2023, and U.S. Provisional Patent Application No. 63/625,630 filed Jan. 26, 2024, the contents of which are incorporated herein in their entirety.

### FIELD OF THE DISCLOSURE

Embodiments of the present disclosure relate to methods and systems for creating stable aerosols. More particularly, the invention relates to improved processes for applying herbicides, insecticides and the like, as an aerosol or vapor using a thermal fogging apparatus.

### BACKGROUND OF THE DISCLOSURE

Agricultural storage applicators use fogging machines to apply liquid sprout control chemicals to potato storage facilities. The foggers turn the liquid into a vapor or fog that is then blown into the storage facility. This is typically achieved through using a high velocity blower, a high temperature heater, and a small pump to introduce the chemical into a high velocity heated air stream in the heated section of the fogging machine. Various companies make a variety of these thermal fogging, including combustion and electric thermal foggers.

Some chemicals used for sprout control will freeze or solidify at room temperature or below (yet above 32 F in some cases). Many methods have been used to keep the chemical in liquid form prior to application so it can be easily pumped through small hoses, tubing, and orifices of the fogging machine apparatus. For example, some of those methods include use of: 1) electric band heaters that are wrapped around the metal container that houses the chemical; 2) large electric or propane heated stainless steel melt tanks into which the chemical is placed to melt or keep the same in a melted state; and 3) use of common heating devices, such as kitchen crock pots, to melt and maintain the chemicals in a fluid state.

In other fogging machine programs, the fogging machine operator modulates either the blower speed, heater temperature, or pump speed to control the heated section of the fogging machine, which requires close and constant supervision and frequent manual adjustments. However, these known application methods do not create a constant and efficient fog or vapor. Typically, large swings in nozzle outlet temperature are observed with just a small adjustment to any one of or combination of the three variables listed above. In addition, such known systems and equipment create significant heat budget issues.

### BRIEF DESCRIPTION OF THE DRAWINGS

FIG. 1 is a schematic diagram showing an embodiment of the method performed through use of a programmable logic controller (PLC) that receives data and controls the main components of the thermal fogger system, including the blower, air heater, output nozzle, peristaltic pump, and chemical preheater;

FIGS. 2A through 2C are schematic diagrams showing the thermal fogging process according to an embodiment of the invention; and

FIG. 3 is a schematic diagram showing the safety alarm phase according to an embodiment of the method that continuously monitors the machine for alarm states.

### DESCRIPTION OF THE DISCLOSURE

The present disclosure is generally drawn to an improved process for applying herbicides, insecticides and the like, as an aerosol or vapor using a thermal fogging apparatus.

In an embodiment of the present disclosure, a chemical pre-heater is utilized to assist with heat budget issues. With the use of a chemical pre-heater, the heat budget issues are resolved via reduction in variation from temperature setpoint. Notably, when the temperature set point of the chemical pre-heater is set, lower swings in the temperature of the heated section of the fogging machine is observed. This results in modulation of the heated section of the fogging machine over long periods of time during an application. The stability of the process results in improved operational efficiency by greatly reducing the amount of human supervision and adjustments required. For example, it was observed that prior to adding the chemical pre-heater and using it to control the heated section of the fogging machine, it was difficult to maintain a window of 20-30° F. In addition, this greatly reduces the complexity of the programming required to control the fogging machine, for example, by maintaining the heated section within a 4-5° F. window throughout the entire application. Adding the use of a chemical preheater greatly reduces the effect of external weather/factors on the outlet temperature.

The present invention can be used to apply chemicals, such as herbicides and insecticides, to stored crops. Below are the temperature ranges and flow rates of six typical chemicals that are typically used in a thermal fogging machine:

| Chemical | Temperature Range | Flow Rate Range |
|---|---|---|
| Dimethylnaphthalene (DMN) | 250 to 750 F. | 1 to 10 gal/hr |
| Clove Oil | 250 to 750 F. | 1 to 10 gal/hr |
| Chloroisopropyl | 250 to 750 F. | 10 lbs to 120 lbs/hr |
| carbamate (CIPC) | | |
| Octanol | 250 to 750 F. | 1 to 15 gal/hr |
| Peracetic Acid (PAA) | 200 to 600 F. | 1 to 40 gal/hr |

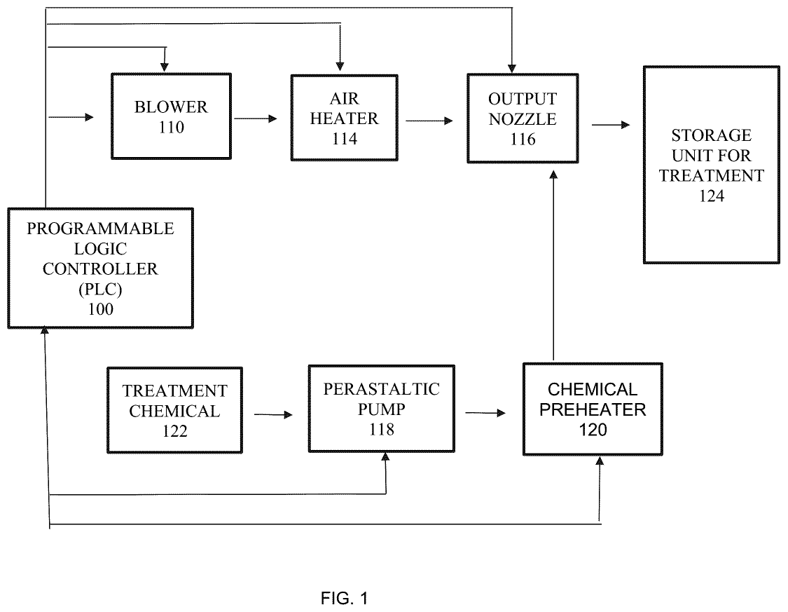

As illustrated in FIG. 1, in a particular embodiment, the method can be performed through use of a programmable logic controller (PLC) 100, that receives data and controls (e.g., sends operating instructions) the main components of the thermal fogger system, including the blower 110, air heater 114, output nozzle 116, peristaltic pump 118, and chemical preheater 120. Such a PLC can include a control or touch screen to facilitate monitoring and operation of the system. To initiate the process, the treatment chemical 122 is either introduced into a container in liquid form or is introduced in solid form and heated until it melts into a liquid. A pump (e.g., peristaltic pump 118) is then activated to transport the liquid chemical into a chemical preheater to raise the temperature of the liquid chemical to a desired temperature (e.g., below the evaporation temperature). The resulting hot liquid chemical is introduced into the output nozzle 116 of the thermal fogger throughout the application process. The thermal fogger blower 110 is set at a desired speed to introduce forced air into the air heater. Upon exiting the air heater 114, the heated air is then introduced into the output nozzle 116. The output nozzle 116 is where the hot air and preheated chemical are introduced and mixed, causing the chemical to turn into a fine thermal fog that is delivered to the storage unit 124. The blower and air heater can be controlled via the PLC 100 and tuned to maintain a desired air speed and air temperature throughout the application process. Simultaneously, the peristaltic pump 118 and preheater temperature can be controlled via the PLC 100 to achieve a desired chemical temperature that, when combined with the air speed and temperature at the output nozzle in the thermal fogger, creates a high-quality fog or vapor that is consistent throughout the application process.

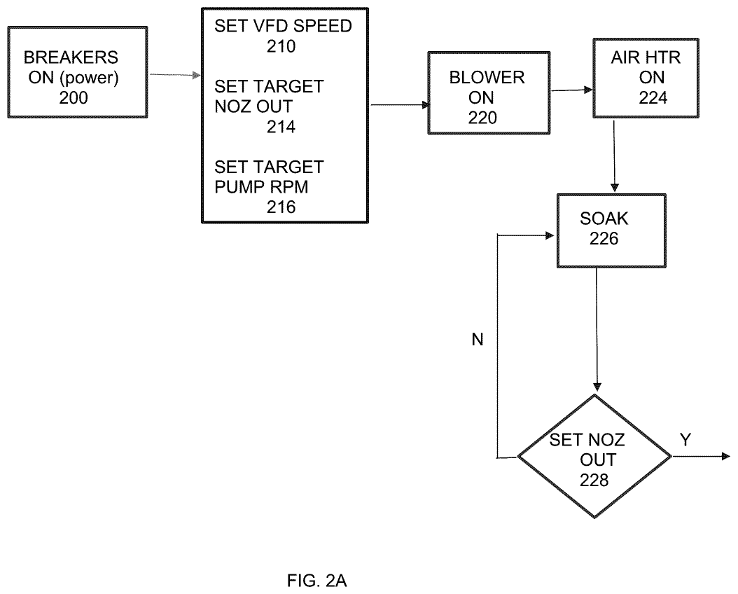

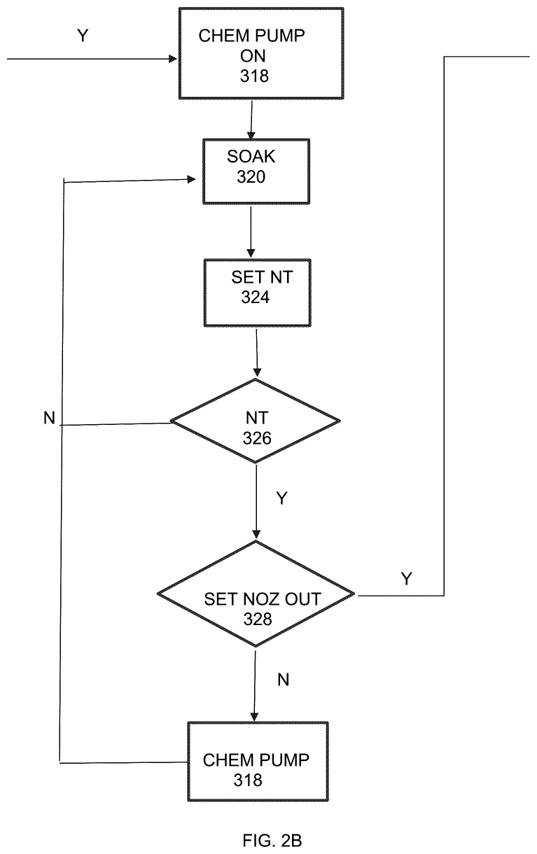

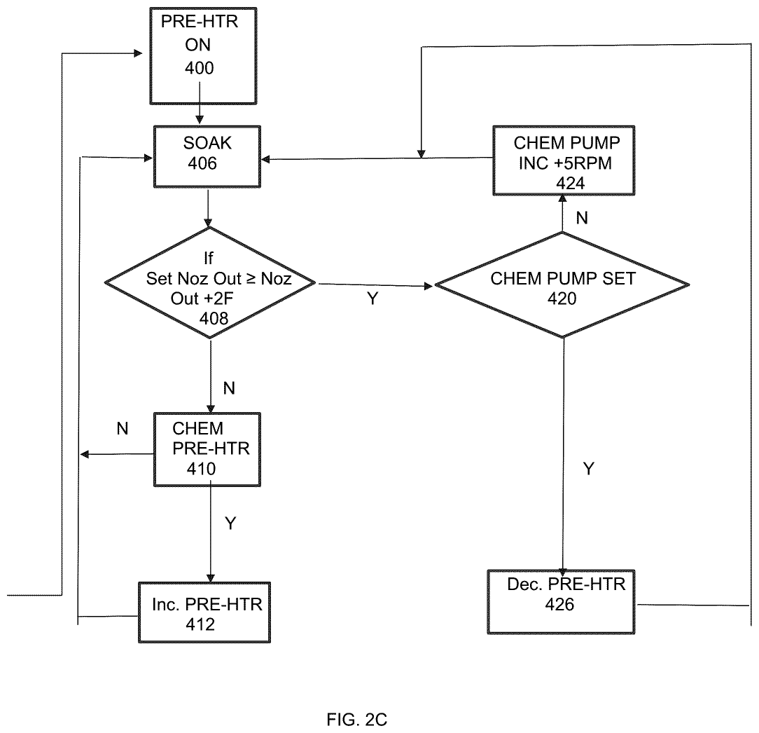

As illustrated in FIG. 2A, in a particular embodiment, the thermal fogging process is initiated during a Startup Sequence, which includes turning the power on 200 the thermal fogger and setting a starting variable frequency speed (VFD) 210, setting a target nozzle temperature (NT) 214, and setting a target pump velocity 216. By way of example, where DMN is utilized as the chemical for application, the VFD can be set at 44 Hz, the nozzle output temperature can be set (e.g., at 575° F.), and the target pump speed can be set (e.g., at 200 RPMs). The blower can then be turned on 220 and allowed to run for a short duration (e.g., 10 seconds) before the air heater is turned on 224. The chemical is allowed to soak 226. The thermal fogger is allowed to continue operating until a desired nozzle output temperature 228 is achieved (e.g., 625° F. for DMN).

Once the desired nozzle output temperature is achieved and maintained, the Coarse Tune loop is initiated, as shown in FIG. 2B. This loop is initiated by activating the chemical pump 318 (e.g., peristaltic pump) that is connected to the treatment chemical container by setting a pump speed (e.g., 130 RPM in the case of DMN). The pump is allowed to run for a short period (e.g., 30 seconds) to allow the treatment chemical to prime and flow through the pump components (i.e., soak 320). A desired nozzle output temperature (NT) 324 is set (e.g., 575° F.). If the nozzle output temperature 326 reaches the desired temperature 328, the chemical pump speed can be modified to adjust the speed of chemical flow. Specifically, the program runs through a course tune program loop, wherein the chemical is pumped through the pre-heater either faster or slower and, based on pump speed, it adds less or more heat to the chemical respectively until the nozzle output temperature is consistently maintained. The chemical is run through the coarse tune loop until the nozzle output temperature is consistently maintained at the desired output temperature, at which point the Fine Tune loop is initiated to achieve a steady state.

FIG. 2C illustrates the Fine Tune loop (aka “Steady State” loop) phase of the method and system. Once the Coarse Tune loop is completed and a consistent nozzle output temperature is maintained, the chemical preheater is activated 400 at a predetermined temperature (e.g., 300° F.). In addition to the above steps to keep the chemical in a melted state, The chemical is allowed to soak 406. The nozzle output temperature is measured 408 and a ‘chemical pre-heater’ 410 is incorporated to raise the temperature 412 of the liquid chemical to a temperature below the evaporation temperature just prior to the chemical entering the high velocity air stream in the heated section of the fogging machine. Once the target temperature of chemical is achieved, the chemical pump rate is set 420 and the speed of the pump can be increased 424 or decreased 426 relative to the desired chemical temperature setting. When the fogger is only required to add a small amount of heat to the chemical to aerosolize or vaporize it, a high quality, thick and dry fog can be achieved can be achieved.

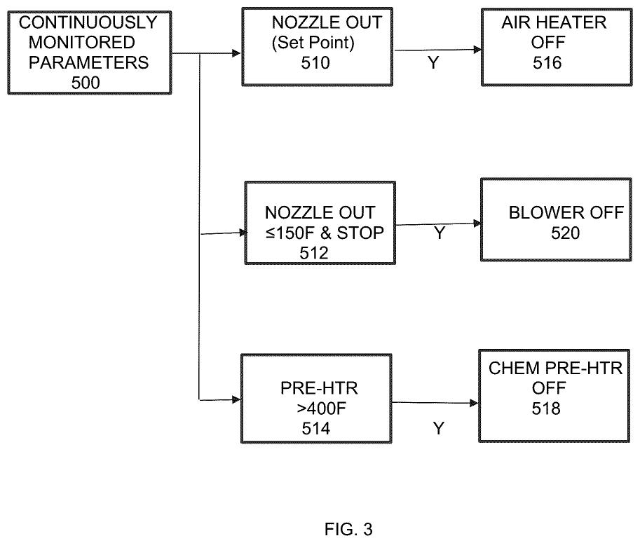

FIG. 3 illustrates the safety alarm phase of the method that continuously monitors the machine for alarm states. This phase is monitored continuously 500 in the background of the program and does not need initiated upon start-up. As illustrated, if any of the alarms are triggered, the machine will shut down promptly and safely.

The chemical is allowed to soak (e.g., about 90 seconds, but variable depending on the speed of the peristaltic pump) to achieve a stable preheated chemical temperature. A nozzle output temperature is set 510 at a predetermined temperature (e.g., 577° F. for DMN) or range (e.g., 577° F. plus or minus 2° F.). Once the desired nozzle output temperature is achieved, the air heater can be turned off 516, and the chemical pump speed can be set at a predetermined speed (e.g., 200 RPM).

If the nozzle output temperature or range is not maintained and drops below the predetermined setpoint 512, the preheater temperature setting is increased 514 (e.g., 5° F.), the blower can be turned off 520, and the fine tune program loop is reinitiated. By doing this, the chemical absorbs more heat as it passes through the pre-heater which in turn raises the nozzle output temperature. This loop is repeated until the desired nozzle outflow temperature is achieved.

If the nozzle output temperature or range is not maintained and raises above the predetermined setpoint, the preheater temperature setting 514 is decreased (e.g., 5° F.), the chemical preheater is turned off 518, and the fine tune program loop is reinitiated. By doing this, the chemical absorbs less heat as it passes through the pre-heater which in turn lowers the nozzle output temperature. This loop is repeated until the desired nozzle outflow temperature is achieved. The preheater is used to finely adjust the nozzle outlet temperature because for every ˜10° F., the preheater changes the nozzle outlet temperature by ˜1-2° F.

1. A method for applying a chemical as an aerosol or vapor using a thermal fogging apparatus comprising:
introducing a chemical in liquid or melted form;
activating a pump to transport the chemical into a chemical preheater to raise the temperature of the chemical to a temperature below the evaporation temperature of the chemical;
introducing the chemical into an output nozzle of the thermal fogging apparatus;
setting a thermal fogger blower at a desired speed to introduce forced air into an air heater;
introducing heated air from the air heater into the output nozzle to thermally fog the chemical.

2. The method of claim 1, wherein the method is performed through use of a programmable logic controller (PLC), that receives data and controls the blower, air heater, output nozzle, peristaltic pump, and chemical preheater of the thermal fogging apparatus.

3. The method of claim 1, wherein the chemical is an herbicide or an insecticide.

4. A method for applying a chemical as an aerosol or vapor using a thermal fogging apparatus comprising:
setting a starting variable frequency speed (VFD), setting a target nozzle temperature (NT), and setting a target pump velocity of the thermal fogging apparatus;
operating the thermal fogging apparatus until a desired nozzle output temperature is achieved;
activating and setting a pump speed on a chemical pump that is connected to a treatment chemical container;
modifying the chemical pump speed to increase or decrease the speed of the chemical flow until the nozzle output temperature is consistently maintained;
activating a chemical preheater at a predetermined temperature to raise the temperature of the chemical to a temperature below the evaporation temperature of the chemical;
soaking the chemical to achieve a stable preheated chemical temperature;
setting a nozzle output temperature at a predetermined temperature;
setting a chemical pump speed at a predetermined speed;
increasing or decreasing the preheater temperature setting if the nozzle output temperature is not maintained within a predetermined temperature;

5. The method of claim 4, wherein the method is performed through use of a programmable logic controller (PLC), that receives data and controls the blower, air heater, output nozzle, peristaltic pump, and chemical preheater of the thermal fogging apparatus.

6. The method of claim 4, wherein the chemical is an herbicide or an insecticide.

7. The method of claim 1, further comprising continuously monitoring the temperature of the chemical in the chemical preheater and the temperature of the chemical at the output nozzle for alarm states.

8. The method of claim 7, further comprising turning off the air heater, blower, and/or chemical preheater when the alarm states are reached.
